(19) United States
(12) Patent Application Publication
(10) Pub. No.: US 2023/0172397 A1
(43) Pub. Date: Jun. 8, 2023

(54) Food Handling Device

(71) Applicant: Williams-Sonoma, Inc., San Francisco, CA (US)

(72) Inventor: Karl Edward Ludeman, Oakland, CA (US)

(21) Appl. No.: 18/062,868

(22) Filed: Dec. 7, 2022

Related U.S. Application Data
(60) Provisional application No. 63/287,348, filed on Dec. 8, 2021.

(51) Int. Cl. A47J 43/28

(52) U.S. Cl. CPC A47J 43/283

(57) ABSTRACT

A food handling device includes two tong arms with each tong arm including a food handling tool at its distal end. The two tong arms are connected by a resilient connecting joint at their proximal ends. The first tong arm food handling tool includes at least one prong. The second tong arm food handling tool includes an angled spatula.

### CLAIM OF PRIORITY

This application claims the benefit of U.S. Provisional Application No. 63/287,348, filed Dec. 8, 2021, the contents of which are hereby incorporated by reference.

### TECHNICAL FIELD

The present disclosure generally relates to kitchen gadgets and tools. More particularly, the present disclosure relates to a food handling device.

### BACKGROUND

Tongs are typically used in a kitchen to handle food items. For instance, tongs may be used while cooking or serving food.

Tongs typically includes two tong arms pivotally attached at one end with mirror-image food handling tools at the other end. Certain textured foods, for instance waffles, may be difficult to pick up using tongs with standard mirror-image food handling tools or ends, especially when removing them from a waffle iron. Therefore, a need for an improvement in tong technology exists.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In a first aspect, a food handling device is disclosed. The food handling device includes a first tong arm having a first proximal end and a first a distal end with a first food handling tool positioned on the first distal end. The first food handling tool includes at least one prong. The food handling device further includes a second tong arm having a second proximal end and a second distal end with a food handling tool positioned on the second distal end. The food handling tool on the second tong arm includes a spatula. Furthermore, a connecting joint located at the proximal ends of the first and second tong arms resiliently connects the first and second tong arms. The connecting joint resiliently urges the first tong arm and the second tong arm towards a resting configuration wherein the first and second tong arms are in a spaced relationship.

### BRIEF DESCRIPTION OF THE DRAWINGS

FIG. 1 is a perspective view of an embodiment of the food handling device of the disclosure;

FIG. 2 is a bottom plan view of the food handling device of FIG. 1;

FIG. 3 is a top plan view of the food handling device of FIGS. 1 and 2;

FIG. 4 is a rear elevational view of the food handling device of FIGS. 1-3;

FIG. 5 is a front elevational view of the food handling device of FIGS. 1-4;

FIG. 6 is a left side elevational view of the food handling device of FIGS. 1-5;

FIG. 7 is a right side elevational view of the food handling device of FIGS. 1-6; and

FIG. 8 is perspective view of the of the food handling device of FIGS. 1-7.

### DESCRIPTION OF THE ILLUSTRATED EMBODIMENTS

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

Food handling devices according to the present disclosure and their individual components may be variously configured without departing from the scope of the present disclosure.

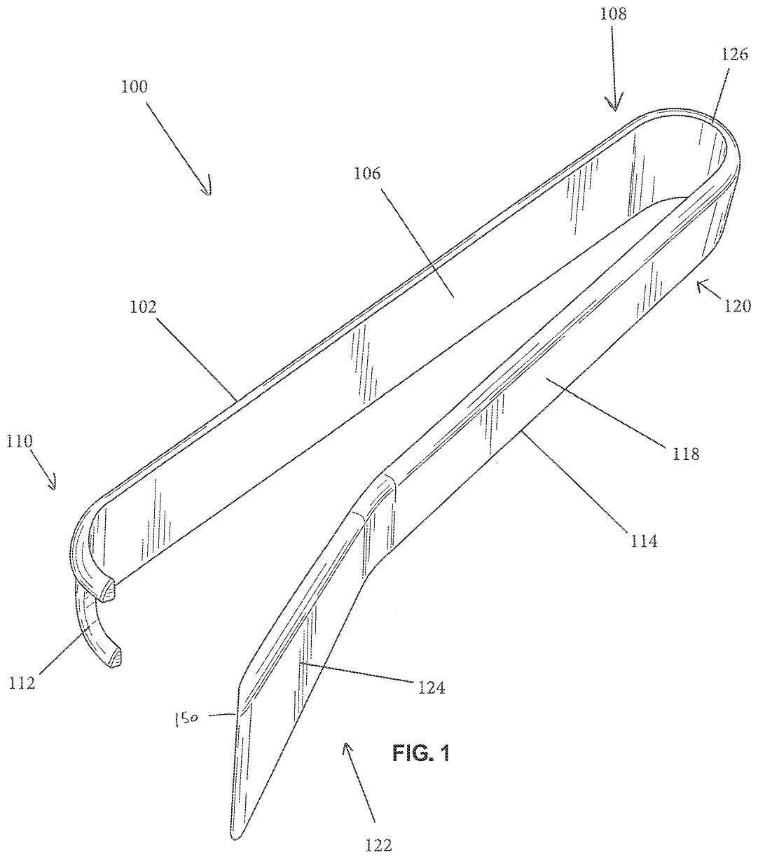

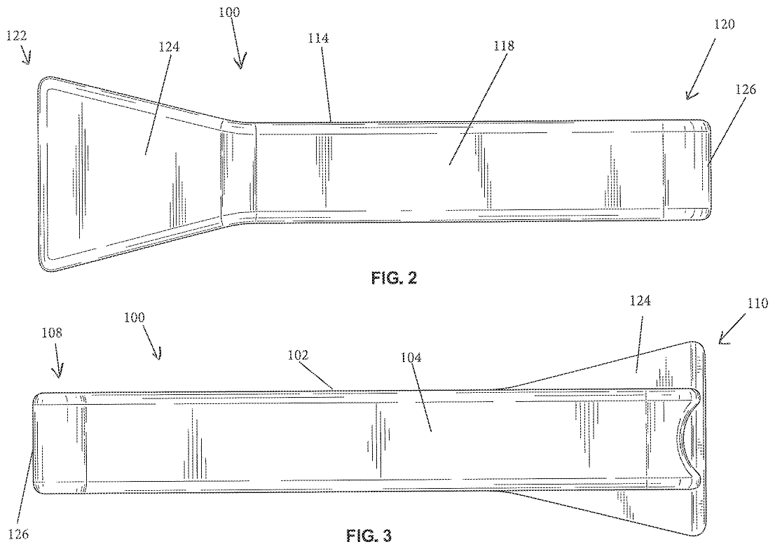

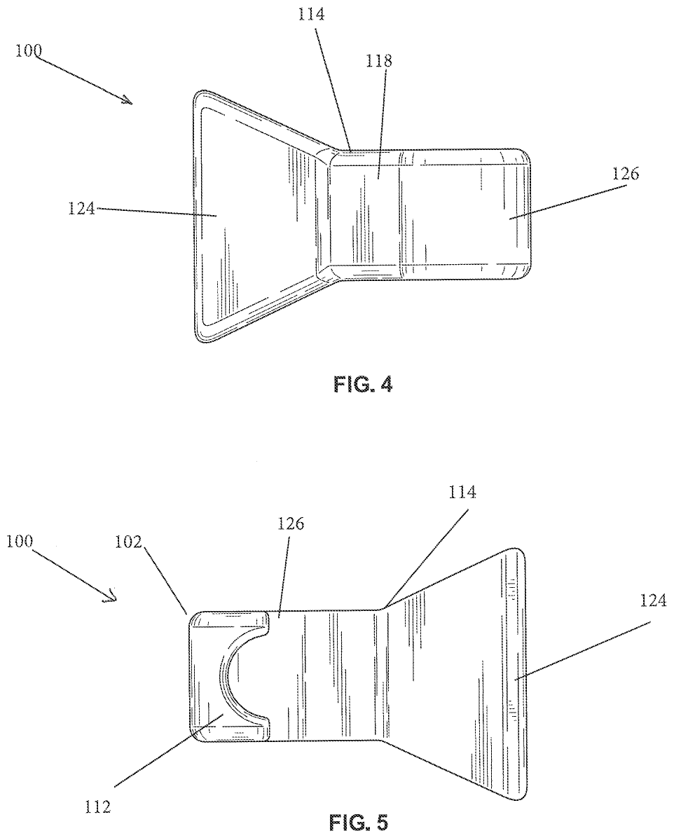

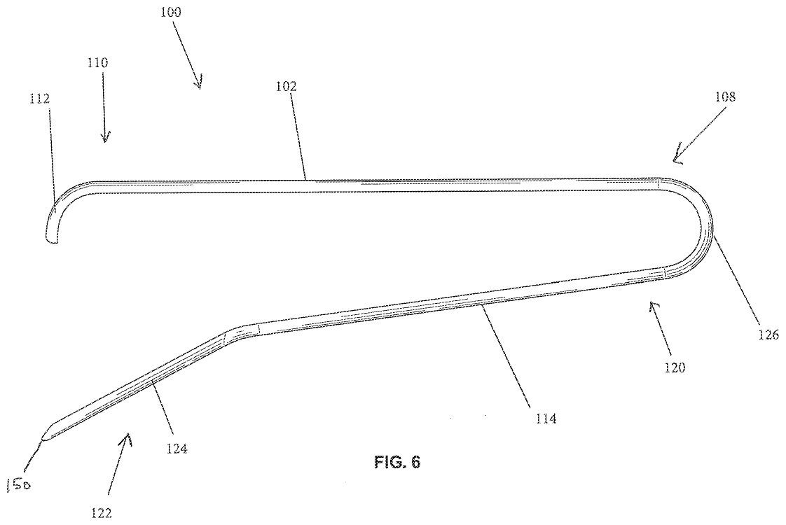

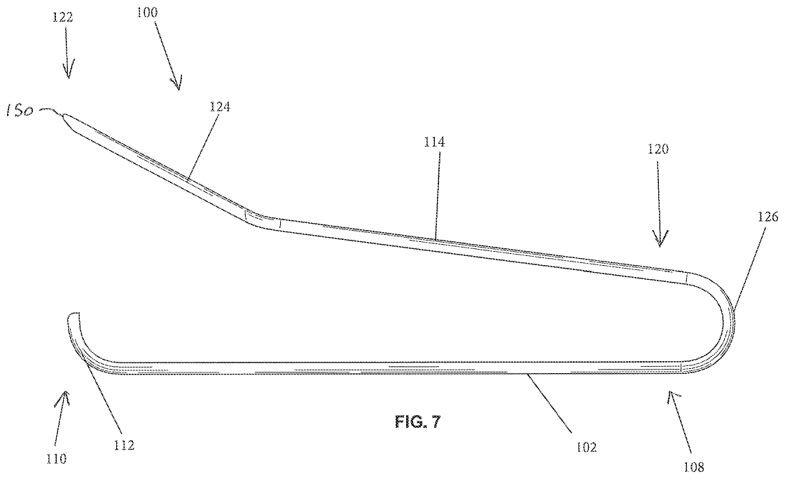

An embodiment of the food handling device of the disclosure is indicated in general at 100 in FIGS. 1-8. The food handling device 100 includes a first tong arm 102, a second tong arm 114, and a connecting joint 126. The first tong arm 102 contains an outer surface 104, an inner surface 106, a proximal end indicated in general at 108, and a distal end indicated in general 110. The second tong arm 114 also contains an inner surface opposing or facing the first tong arm inner surface 106, an outer surface 118, a proximal end indicated in general at 120, and a distal end indicated in general at 122. A food handling tool is located at the distal end 110, 122 of each tong arm 102, 114.

The connecting joint 126 is located at the proximal ends 108, 120 of the first and second prong arms 102, 114, connecting them to one another. In the illustrated embodiment, the connecting joint 126 includes a U-shaped joint made of a resilient material. The resilient material may be, as examples only, plastic or other resilient material known in the art. As shown in FIGS. 1, 6, and 7, the resilience of the connecting joint 126 urges the first tong arm 102 and the second tong arm 114 apart and into open, spaced positions or a spaced relationship whereby the food handling device is in a rest configuration. Other connecting joints known in the art may be used without departing from the scope of the present disclosure.

In the illustrated embodiment, the first tong arm 102, the second tong arm 114, and connecting joint 126 are made of a continuous resilient material, such as plastic.

As seen in FIGS. 1, 5, and 6-8, the food handling tool at the distal end 110 of the first tong arm 102 includes a number of prongs 112. In the illustrated embodiment, the prongs 112 include two prongs, but more or less may be used without departing from the scope of the disclosure. The prongs may curve inward or towards the second tong arm 114.

Furthermore, as seen in FIGS. 1-8, the food handling tool at the distal end 122 of the second tong arm 114 includes a spatula 124. The spatula 124 is angled away from the first tong arm 102. In the illustrated embodiment, the spatula 124 has a proximal end positioned on the distal end 122 of the second tong arm 114. The spatula also has a distal end extending from the spatula proximal end. The proximal end of the spatula 124 may have a similar width to the second tong arm 114 and the distal end of the spatula 124 is wider than the width of the second tong arm 114. In addition, the edge of the distal end of the spatula 124 may be provided with a taper 150 (FIGS. 1, 6 and 7) to facilitate sliding the spatula under a food item.

The longitudinal length of the first tong arm 102, including prongs 112, is preferably shorter than that of the second tong arm 114, including the spatula 124. As a result, the prongs 112 are positioned to engage the spatula 124 when the food handling device 100 is moved and deflected into a fully closed configuration.

A user may use the tongs to remove a waffle from a waffle iron by grasping the outer surfaces 104 and 118 of the first and second tong arms, respectively, inserting the angled spatula 124 between the waffle and the waffle iron, or under another food item, and then squeezing the first tong arm 102 and the second tong arm 114 towards one another. As a result, the prongs 112 of the first tong arm 102 engage the cavities of a waffle to hold the waffle in place against the spatula 124 of the second tong arm 114 so that the waffle may be lifted. The angled position of the spatula 124 allows a user to wedge the tool between a waffle and a waffle iron more easily, facilitating removal and lifting of the waffle.

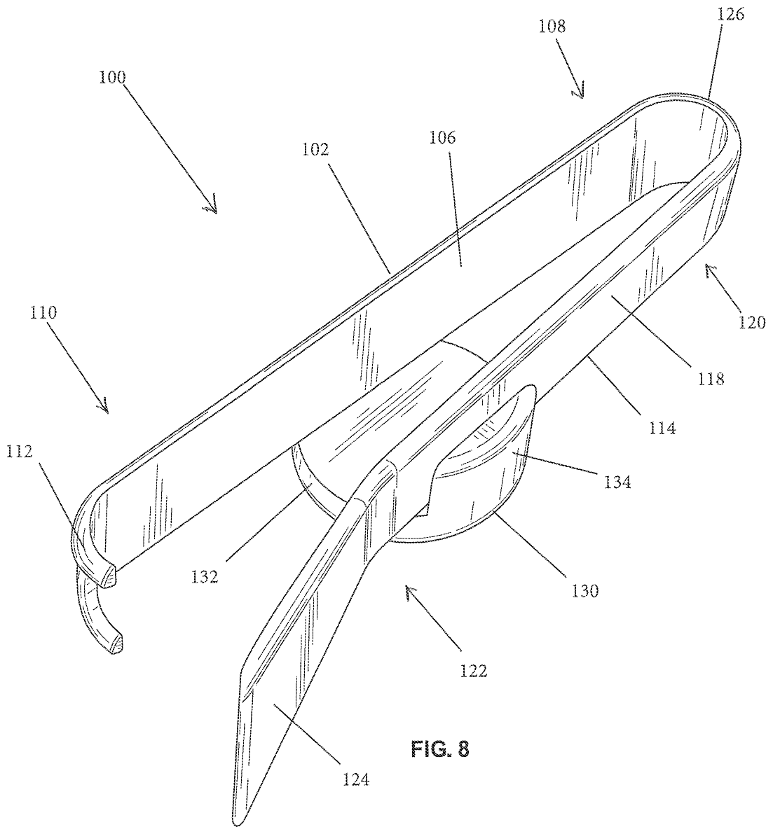

As seen in FIG. 8, the food handling device 100 may be provided with a holder 130 configured to receive the food handling device 100 for storage. The holder may include a circular base 132 with two spaced and opposing walls 134 extending perpendicularly from opposite edges of the base 132 so that a recess is defined therebetween. To store the food handling device 100, a user may slightly close the food handling device 100 from the rest configuration. While the pressure is applied, the food handling device 100 is placed within the recess defined by the opposing walls 134 of the holder 130. When the user releases the food handling device 100, the outer surfaces 104 and 118 of the first tong arm and the second tong arm, respectively, contact the opposing, inward facing surfaces of the walls 134, holding the food handling device 100 in place due to the resiliency of joint 126 and frictional forces between the tong arm outer surfaces and the inward facing surfaces of the walls 134. In one embodiment of the device 100, the holder 130 is provided with magnets on the bottom of the circular base 132, allowing the holder to stick to certain kitchen appliances having metallic surfaces. Of course the holder may be provided with a shape other than round.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. A food handling device comprising:
a first tong arm having a first proximal end and a first distal end;
a second tong arm having a second proximal end and a second distal end;
a first food handling tool positioned on the first distal end of the first tong arm, wherein the first food handling tool includes at least one prong angled towards the second tong arm;
a second food handling tool positioned on the second distal end of the second tong arm, wherein the second food handling tool includes a spatula angled away from the first tong arm; and
a connecting joint joining the first and second proximal ends of the first and second tong arms, said connecting joint resiliently urging the first tong arm and the second tong arm towards a resting configuration wherein the first and second tong arms are in a spaced relationship.

2. The food handling device of claim 1, wherein the connecting joint includes a U-shaped joint made of a resilient material.

3. The food handling device of claim 2, wherein the first tong arm, second tong arm, and the U-shaped joint are made of a continuous piece of plastic or other resilient material.

4. The food handling device of claim 1, wherein the first food handling tool includes at least two prongs.

5. The food handling device of claim 1, wherein the spatula has a spatula proximal end joined to the second distal end of the second tong arm and a spatula distal end extending from the spatula proximal end, wherein the spatula proximal end has a same width as the second tong arm and the spatula distal end is wider than a width of the second tong arm.

6. The food handling device of claim 5 wherein the spatula distal end includes an edge that is tapered.

7. The food handling device of claim 1, wherein the first tong arm is shorter than the second tong arm.

8. The food handling device of claim 1 wherein the spatula includes a spatula distal end with an edge that is tapered.

9. The food handling device of claim 1, further comprising a holder configured to receive the food handling device, wherein the holder includes a base with two opposing walls extending from the base so that a recess is defined therebetween, wherein the recess is configured to receive the first and second tong arms when deflected from the resting configuration with a first one of the opposing walls engaging the first tong arm and a second one of the opposing walls engaging the second tong arm so that the food handling device is secured within the recess.

10. The food handling device of claim 9, wherein the base of the holder includes magnets.
